(19) United States
(12) Patent Application Publication
(10) Pub. No.: US 2005/0005294 A1
(43) Pub. Date: Jan. 6, 2005

(54) Image display system

(76) Inventors: Tomomasa Kojo, Tokyo (JP); Takashi Koya, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/864,384

(22) Filed: Jun. 10, 2004

(30) Foreign Application Priority Data
Jul. 3, 2003 (JP) P2003-270834

(51) Int. Cl. G06F 13/00

(52) U.S. Cl. 725/51

(57) ABSTRACT

In an image display system, image display apparatus and image display method capable of displaying an image based on content information having a plurality of links on the image display apparatus, a control means for controlling the display state of the image based on the content information being displayed on the image display apparatus and a mode switching means for switching the operation mode of the control means between a first mode and a second mode according to external operation are provided. In a situation where part of the image based on the content information is displayed on the display screen of the image display apparatus, the control means is able to scroll the image on the display screen in the first mode and sequentially select a link in the image fixed on the display screen in the second mode, according to external operation.

### BACKGROUND OF THE INVENTION

1. Field of the Invention

This invention relates to an image display system, an image display apparatus, and an image display method, and is suitably applied to a television receiver capable of accessing the Internet, for example.

2. Description of the Related Art

Webs (that is, WWW: world wide web) have been widely used, which are an information network where various information in servers on the Internet are linked to each other so as to be searchable. A user accesses a desired Web site with his/her personal computer so as to browse various Web pages registered in the Web site.

In addition, not only personal computers but also television receivers have been proposed and produced, which enable users to browse Web pages on the Internet. In such television receivers, modems and Web browsers capable of accessing the Internet are installed, or set-top boxes containing these devices are externally attached (for example, refer to Japanese Patent Application Laid-Open No. 2002-358435 (fifth paragraph-sixth paragraph, FIG. 1)).

By the way, when a user accesses a desired Web site to display a Web page on a display screen, such a television receiver may display only part of the Web page on the display screen when the Web page screen is too large.

Usually, a Web page screen has a plurality of links with graphical user interface (GUI) which allows a current Web page to be jumped to another Web page. The user uses a remote commander or the like to select a link corresponding to a desired Web page out of the plurality of links.

When the user selects a link existing outside the display screen while he/she operates the remote commander to select a link, the television receiver scrolls a displayed part up, down, right and left in response to the link selection.

Therefore, a scroll pitch of the displayed part being displayed on the display screen of the television receiver is determined by a layout, that is, the number and positions of links on the Web page screen, so that the user viewing the displayed part, which is scrolled on a link basis, hardly recognizes which part of the Web page is being displayed.

This problem happens apparently as a Web page is larger as compared with the display screen of the television receiver and as a proportion of small character letters such as paper to a Web page is larger, so that the user hardly grasps the entire Web page.

In addition, because the display screens of television receivers generally have lower resolution as compared with the display screens of personal computers, the television receivers have an enlarged display function but does not have a reduced display function. Even if the reduced display function is applied, users would have trouble reading because of the low resolution.

### SUMMARY OF THE INVENTION

This invention has been made in view of the foregoing points and is to propose an image display system, image display apparatus and image display method capable of offering improved user usability.

To solve the above problems, this invention provides an image display system composed of an image display apparatus for displaying an image based on content information having at least one link on a display screen and an operating device for operating the displayed contents of the display screen of the image display apparatus. The image display apparatus comprises a control means for controlling the display state of the image based on the content information being displayed on the display screen and a mode switching means for switching the operation mode of the control means between first and second modes according to operation of the operating device. In a situation where part of the image based on the content information is displayed on the display screen of the image display apparatus, the control means scrolls the image on the display screen in the first mode and sequentially selects a link in the image fixed on the display screen in the second mode, according to the operation of the operating device.

As described above, in this image display system, in a situation where part of an image based on content information is displayed on the display screen of the image display apparatus, the first and second modes are alternatively switched according to the operation of the operating device. Since the image is not scrolled on the display screen in response to link selection, a user is able to easily select a desired link while easily confirming the entire image with simple operation, thus making it possible to realize an image display system capable of offering improved user usability.

Further, this invention provides an image display apparatus for displaying an image based on content information having at least one link on a display screen. This apparatus comprises a control means for controlling the display state of the image based on the content information being displayed on the display screen and a mode switching means for switching the operation mode of the control means between first and second modes according to external operation. In a situation where part of the image based on the content information is displayed on the display screen, the control means scrolls the image on the display screen in the first mode and sequentially selects a link in the image fixed on the display screen in the second mode, according to external operation.

As described above, in the image display apparatus, in a situation where part of an image based on content information is displayed on the display screen, the first and second modes are alternatively switched according to external operation. Since the image is not scrolled on the display screen on a link basis in response to link selection, a user is able to easily select a desired link while easily confirming the entire image with simple operation, thus making it possible to realize an image display apparatus capable of offering improved user usability.

Still further, this invention provides an image display method of displaying an image based on content information having at least one link on a display screen. With this image display method, the operation mode for controlling the display state of the image based on the content information being displayed on the display screen is switched between first and second modes according to external operation. In a situation where part of the image based on the content information is displayed on the display screen, the image is scrolled on the display screen in the first mode and a link is sequentially selected in the image fixed on the display screen in the second mode, according to external operation.

As described above, with the image display method, in a situation where part of an image based on content information is displayed on the display screen, the first and second modes are alternatively switched according to external operation. Since the image is not scrolled on the display screen on a link basis in response to link selection, a user is able to easily select a desired link while easily confirming the entire image with simple operation, thus making it possible to realize an image display method capable of offering improved user usability.

The nature, principle and utility of the invention will be comes more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a block diagram showing a construction of a television receiving system according to this embodiment;

FIG. 2 is a schematic perspective view of an appearance of a remote commander shown in FIG. 1;

FIGS. 3A, 3B, 4A and 4B are schematic plane views showing display states of a monitor for explaining a mode switching process;

FIG. 5 is a flowchart explaining a Web page display procedure; and

FIGS. 6A and 6B are schematic plane views showing display states of the monitor for the operation modes of the remote commander.

### DETAILED DESCRIPTION OF THE EMBODIMENT

preferred embodiments of this invention will be described with reference to the accompanying drawings:

### (1) Construction of a Television Receiving System According to This Embodiment

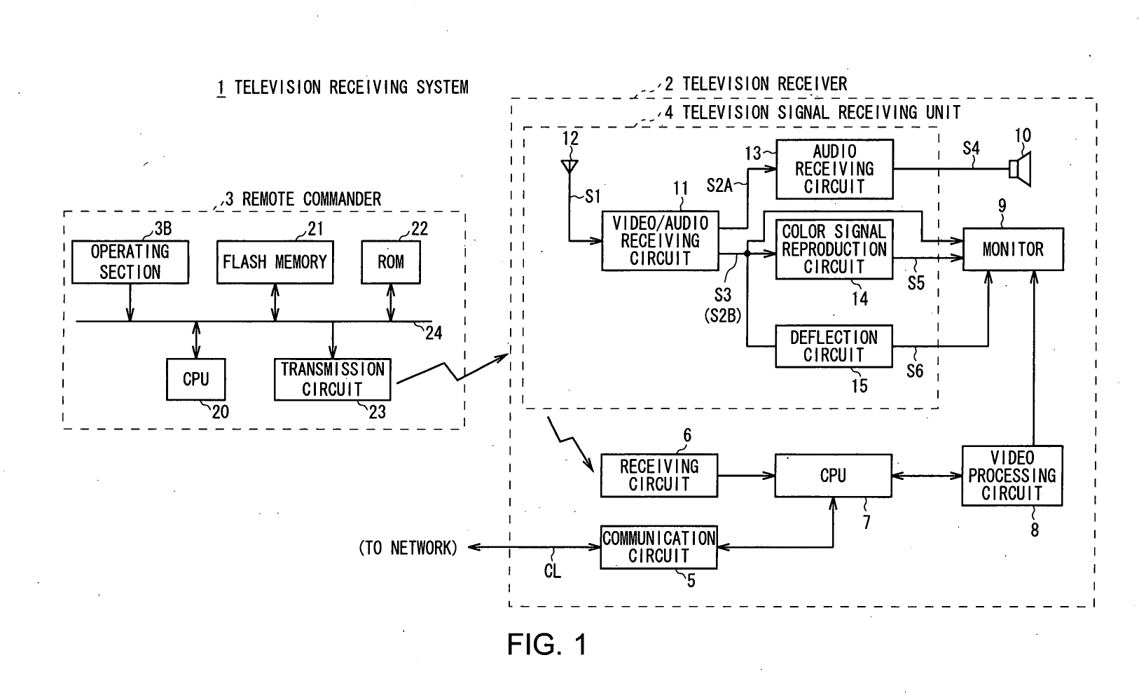

Referring to FIG. 1, reference numeral 1 shows a television receiving system according to this embodiment and is composed of a television receiver 2 connectable to a network (not shown) such as the Internet and a remote commander 3 for remote radio control of the television receiver 2.

In this case, the television receiver 2 is composed of a television signal receiving unit 4 for reproducing video and audio based on a color television signal S1 obtained by receiving ground waves or satellite waves, a communication circuit 5 for accessing various Web sites via the network, a receiving circuit 6 for performing infrared communication based on, for example, infrared data association (IrDA) standards with the remote commander 3, a central processing unit (CPU) 7 for controlling various information received from the communication circuit 5 and the receiving circuit 6, a video processing circuit 8 for creating a video signal for monitor display based on the various information under the control of the CPU 7, and a monitor 9 and loudspeaker 10 for outputting video and audio received from the television signal receiving unit 4 and the video processing circuit 8.

In this television signal receiving unit 4, a video/audio receiving circuit 11 first extracts the signal of a designated channel from television radio waves (color television signal) S1 received via an antenna 12, converts it into an intermediate frequency signal, and amplifies the intermediate frequency signal to divide it to an audio intermediate frequency signal S2A and a video intermediate frequency signal S2B.

Then the video/audio receiving circuit 11 sends the audio intermediate frequency signal S2A to an audio receiving circuit 13, while extracting a color video signal S3 which comprises modulation components from the video intermediate frequency signal S2B and sending it to a color signal reproduction circuit 14, a deflection circuit 15 and the monitor 9.

The audio receiving circuit 13 extracts an audio signal S4 by performing frequency-modulation (FM) detection on the audio intermediate frequency signal S2A received from the video/audio receiving circuit 11, amplifies the audio signal S4 and drives the loudspeaker 10, thereby outputting sound based on the audio signal S4 from the loudspeaker 10.

The color signal reproduction circuit 14 extracts and amplifies carrier color signal components from the color video signal S3 received from the video/audio receiving circuit 11, and demodulates the carrier color signal to produce a three-primary color signal S5.

The deflection circuit 15 extracts a synchronization signal from the color video signal S3 received from the video/audio receiving circuit 11 and frequency-divides this synchronization signal into a horizontal synchronization signal and a vertical synchronization signal. The deflection circuit 15 generates horizontal- and vertical-direction deflection signals S6 based on the horizontal synchronization signal and the vertical synchronization signal obtained by the frequency division, so that composition of an image on a sending end matches restoration of the image on a receiving end.

Thus the monitor 9 playbacks video based on the received color television signal S1 based on the color video signal (luminance signal) S3 from the video/audio receiving circuit 11, the three-primary color signal S5 from the color signal reproduction circuit 14, and the deflection signals S6 from the deflection circuit 15.

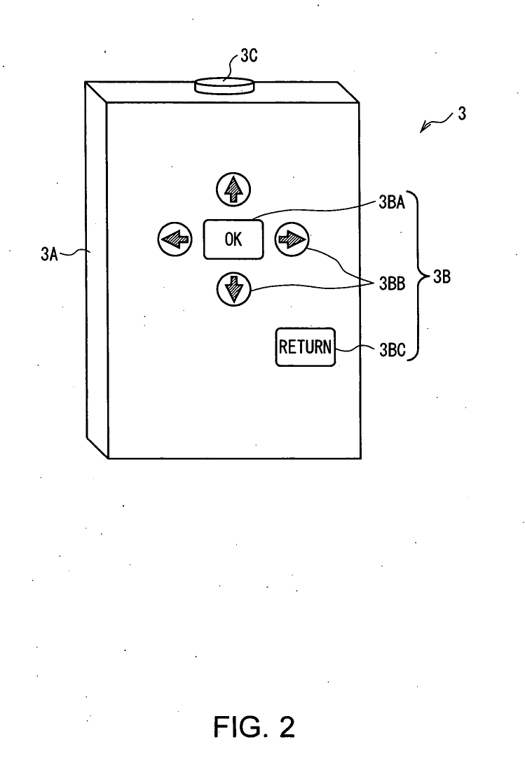

The remote commander 3, on the other hand, has a plane rectangular solid body 3A as shown in FIG. 2. An operating section 3B composed of buttons to be pressed assigned various functions is arranged on its surface. On the top surface, an infrared communication port 3C based on the same communication standards as the television receiver 2 is arranged.

The buttons of this operating section 3B includes an “OK” key 3BA for confirming various setting states in the center, and cursor keys 3BB positioned so as to surround the OK key 3BA. In addition, a return key 3BC assigned a prescribed function is arranged at a lower-right position of the cursor keys 3BB.

Referring to FIG. 1, this remote commander 3 is composed of a CPU 20, the operating section 3B, a flash memory 21, a read-only memory (ROM) 22 for program, and a transmission circuit 23, which are connected via a bus 24. In addition, a battery such as a button battery (not shown) is contained as a power source.

The CPU 20 reads a corresponding program out of various programs being stored in the flash memory 21 in response to user operation of the operating section 3B and puts it in the ROM 22 for program, thereby performing various control processes with this program. In addition, the transmission circuit 23 transmits data received from the CPU 20, via the infrared communication port 3C (FIG. 2).

Further, in FIG. 1, in the television receiver 2, the communication circuit 5 has a modem (not shown) connectable to the network so as to communicate with various Web servers on the network via the communication cable CL being connected to the modem and then public circuit network (not shown).

When the CPU 7 receives various data for the Web pages of a designated Web site via the network from the communication circuit 5 based on operation of the remote commander 3 received via the receiving circuit 6, it sends the various data to the video processing circuit 8. The video processing circuit 8 has a prescribed Web browser and uses this Web browser under the control of the CPU 7 to create video data indicating the Web page screens from the various data and sends the video data to the monitor 9.

As a result, the monitor 9 is able to display various Web page screens of the Web page that the user designated with the remote commander 3.

Further, when this television receiver 2 determines based on the operation of the remote commander 3 received via the receiving circuit 6 that a link on a Web page screen being displayed on the monitor 9 has been selected, the CPU 7 designates the uniform resource locator (URL) and hypertext markup language (HTML) file name corresponding to the link by using the Web browser installed in the video processing circuit 8, so as to access the Web server on the network via the communication circuit 5, thus obtaining and displaying the desired Web page on the monitor 9.

### (2) Mode Switching Process

In the television receiving system 1, when the television receiver 2 side accesses a designated Web site on the network and displays a designated Web page screen on the monitor 9, the CPU 7 sets the operation mode of the remote commander 3 to a scroll mode.

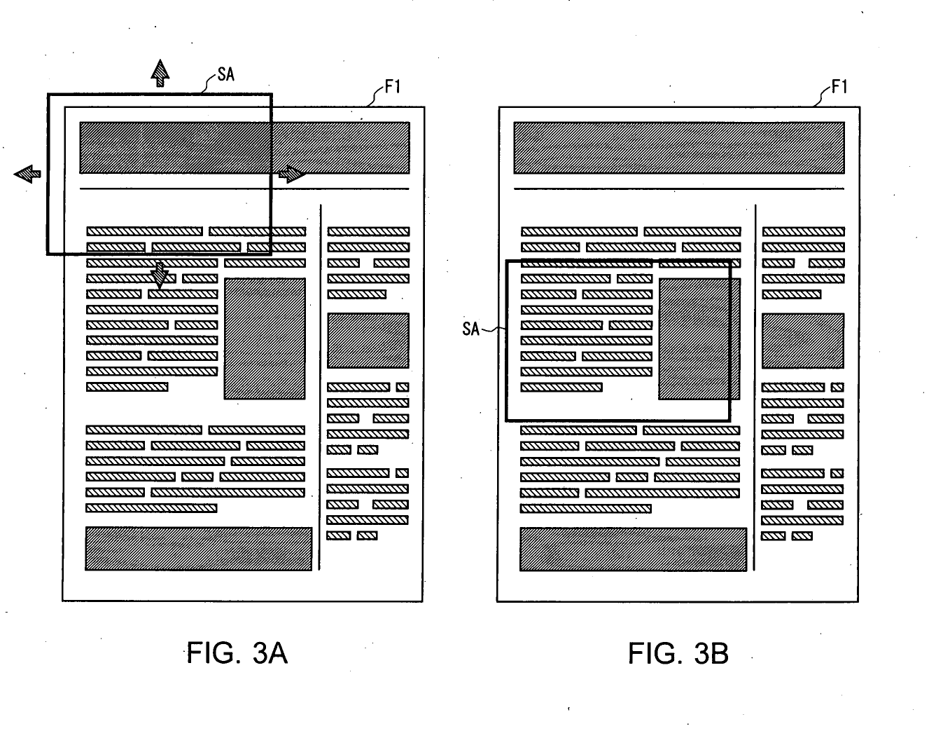

In a case where the Web page screen is too large and only part of the screen is displayed on the monitor 9, an upper-left part of the Web page screen F1 is first displayed on a display area SA of the monitor 9 as shown in FIG. 3A.

In this scroll mode, when the user presses a cursor key 3BB (FIG. 2) of the operating section 3B on the remote commander 3 to designate a desired direction, the CPU 7 uses the Web browser to display the Web page screen F1 in the designated direction on the display area SA of the monitor 9.

In this case, in the scroll mode, a scroll pitch for one press and a scroll speed corresponding to a pressing time are previously set for the cursor keys 3BB of the operating section 3B on the remote commander 3.

Therefore, the Web page screen F1 being displayed on the display area SA of the monitor 9 is scrolled according to a pressing number and time of the cursor keys 3BB, regardless of links set in the Web page screen F1 by means of GUI.

When the user presses the OK key 3BA of the operating section 3B since the desired part of the Web page screen is displayed on the display area of the monitor 9 (FIG. 3B), the CPU 7 of the television receiver 2 switches the operation mode of the remote commander 3 from the scroll mode to a link select mode.

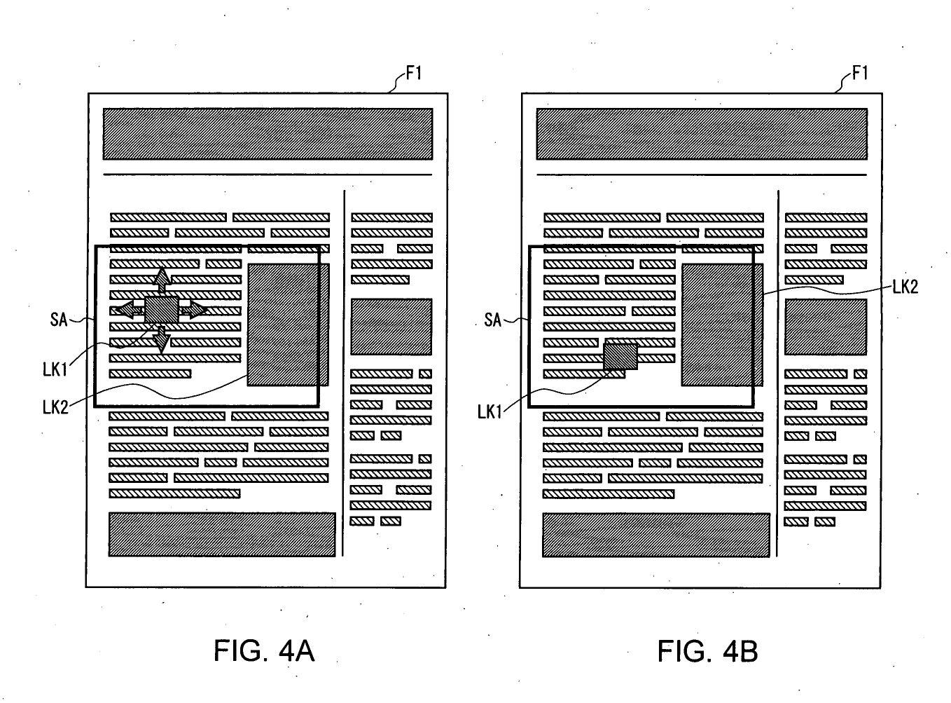

In this link select mode, the part of the Web page screen F1 is fixed on the display area SA of the monitor 9. Therefore, even when the user presses a cursor key 3BB of the operating section 3B on the remote commander 3 for a desired direction, the Web page screen F1 is not be scrolled but a link LK1, LK2 out of a prescribed number of links, which are set in the Web page screen F1 by the GUI setting, is sequentially selected on the display area SA of the monitor 9 according to the pressing number and time of the cursor keys 3BB (FIG. 4A).

At this time, when a link desired by the user is not displayed on the display area SA of the monitor 9 and the user desires to search another part of the Web page screen F1, he/she just presses the return key 3BC, so that the CPU 7 of the television receiver 2 switches the operation mode of the remote commander 3 from the link select mode to the scroll mode.

When the user presses the OK key 3BA of the operating section 3B with the desired link LK1 selected in the Web page screen F1 being displayed on the display area SA of the monitor 9, the CPU 7 of the television receiver 2 uses the Web browser to designate the URL and HTML file name corresponding to the link, thereby accessing the corresponding Web server on the network and obtaining and displaying the corresponding Web page on the display area SA of the monitor 9.

As described above, this television receiver 1 is able to position a Web page screen while scrolling the screen in user-designated directions on a prescribed pitch basis in a situation where part of the Web page screen desired by the user is displayed on the display area of the monitor 9, and then to jump to another Web page screen corresponding to a desired link by designating the link in the Web page screen being displayed on the display area of the monitor 9.

### (3) Web Page Display Procedure

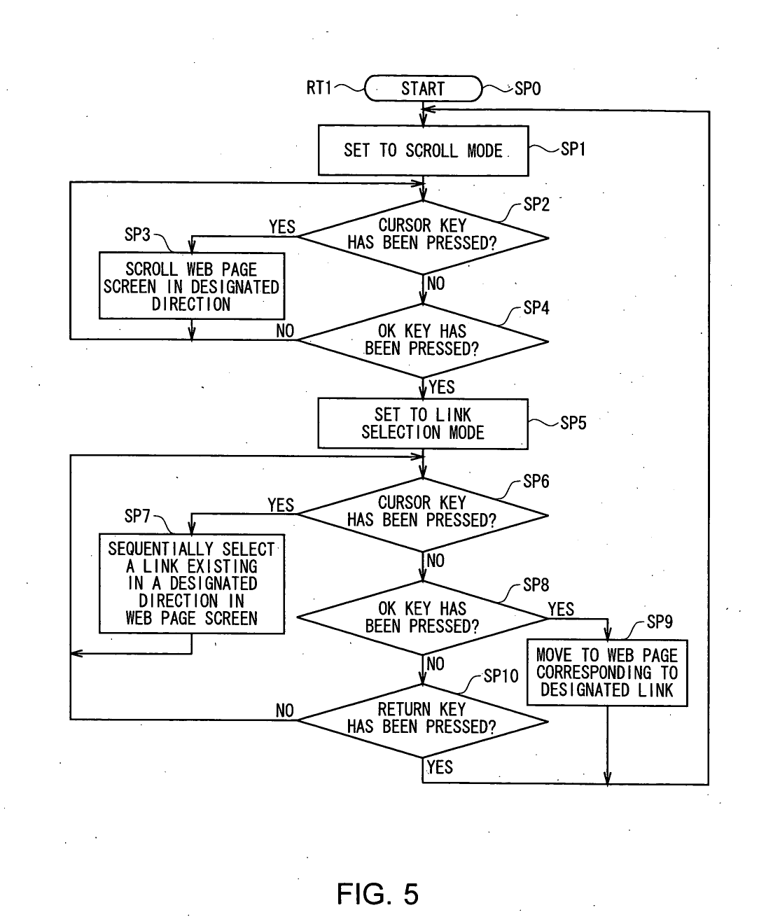

When a user-desired Web page screen is displayed on the monitor 9, the CPU 7 of the television receiver 2 enters the Web page display procedure RT1 shown in FIG. 5 for performing the above mode switching from step SP0, sets the operation mode to the scroll mode in step SP1, and then moves to step SP2.

In this step SP2, the CPU 7 determines whether a cursor key 3BB of the operating section 3B on the remote commander 3 has been pressed. When an affirmative result is obtained, the CPU 7 moves on to step SP3 where it scrolls the Web page screen in the designated direction on the display area of the monitor 9. Then the CPU 7 returns back to step SP2 until a negative result is obtained.

When a negative result is obtained in this step SP2, the CPU 7 moves to step SP4 where it waits for the OK key 3BA of the operating section 3B to be pressed. When an affirmative result is obtained in this step SP4, the CPU 7 moves to step SP5 where it switches the operation mode from the scroll mode to the link select mode.

Then the CPU 7 moves to step SP6 where it determines whether a cursor key 3B of the operating section 3B has been pressed. When an affirmative result is obtained, the CPU 7 moves to step SP7 where it sequentially selects a link existing in a designated direction on the Web page screen within the display area of the monitor 9. The CPU 7 returns to step SP6 and repeats this process until a negative result is obtained.

When a negative result is obtained in step SP6, the CPU 7 moves to step SP8 where it waits the OK key 3BA of the operating section 3B to be pressed. When an affirmative result is obtained in this step SP8, the CPU 7 moves to step SP9 where the Web page screen corresponding to the determined link is displayed on the display area of the monitor 9, and returns back to step SP1 where it switches the operation mode to the scroll mode.

When a negative result is obtained in step SP8, on the contrary, the CPU 7 moves to step SP10 where it determines whether the return key 3BC of the operating section 3B has been pressed. Only when an affirmative result is obtained, the CPU 7 returns back to step SP1 where it switches the operation mode to the scroll mode.

As described above, the CPU 7 of the television receiver 2 alternatively switches the operation mode of the remote commander 3 between the scroll mode and the link select mode, according to the operation of the remote commander 3, so that the user is able to operate the remote commander 3 in the scroll mode or the link select mode.

### (4) Operation and Effects of This Embodiment

In the above configuration, in the television receiving system 1, while a designated Web page screen is displayed on the monitor 9 of the television receiver 2, the television receiver 2 sets the operation mode of the remote commander 3 to the scroll mode.

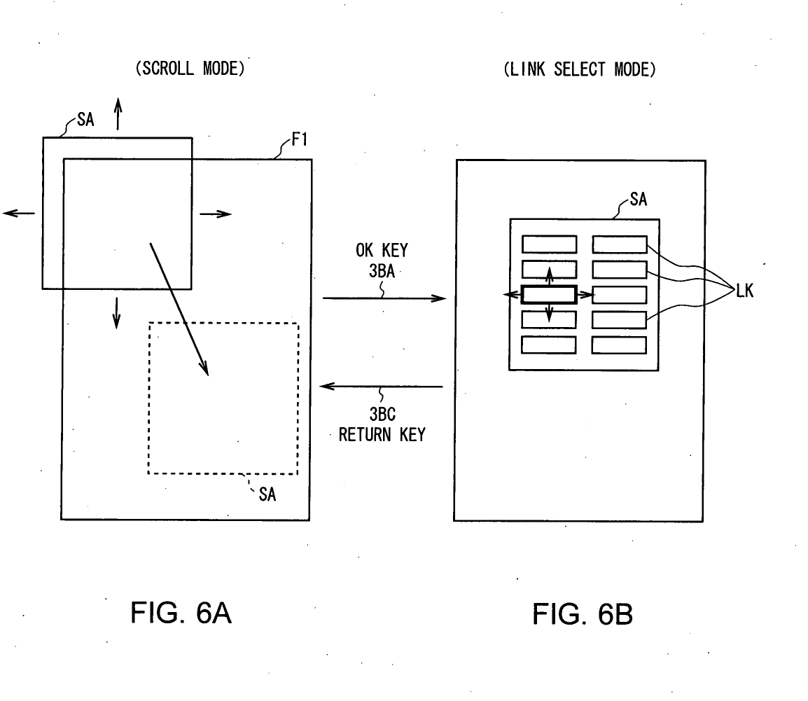

When a cursor key 3BB of the operating section 3B on the remote controller 3 is pressed in a situation where the Web page screen F1 is too large and only part of it is displayed on the display area SA of the monitor 9, the Web page screen F1 is scrolled on a prescribed pitch basis in a designated direction on the display area SA of the monitor 9 (FIG. 6A).

The user is able to scroll the Web page screen F1 in a designated direction on the display area SA of the monitor 9 on a desired scroll pitch basis and at a desired scroll speed, which allows the user to easily browse the Web page screen F1 as desired, as compared with a conventional case where the scroll is made on a link basis in response to link selection.

When the user presses the OK key 3BA of the operating section 3B on the remote commander 3 with the desired part of the Web page screen F1 displayed on the display area SA of the monitor 9, the television receiver 2 fixes the part of the Web page screen F1 on the display area SA of the monitor 9 and switches the operation mode of the remote commander 3 to the link select mode.

When a cursor key 3BB of the operating section 3B of the remote commander 3 is pressed in this situation, the television receiver 2 sequentially selects a link LK existing in the desired direction, out of prescribed links existing in the Web page screen F1 being displayed on the display area SA of the monitor 9 (FIG. 6B).

Since the user selects a link LK existing in a designated direction on the display area SA of the monitor 9 link-by-link, he/she is able to select a desired link LK more easily, as compared with a case, for example, where a mouse is used to designate a link on a Web page screen, like a personal computer.

Further, when the user wants to browse another part of the Web page screen F1 which is not displayed on the display area SA of the monitor 9, the operation mode of the remote commander 3 can be switched to the scroll mode by just pressing the return key 3BC of the operating section 3B of the remote commander 3. This does not bother the user in view of the operability.

When the OK key 3BA of the operating section 3B of the remote commander 3 is pressed to confirm a desired link LK in the Web page screen F1 being displayed on the display area SA of the monitor 9, the Web page corresponding to the link is obtained via the network, thereby displaying the Web page screen (not shown) on the display area SA of the monitor 9.

As described above, the television receiver 2 alternatively switches the operation mode of the remote commander 3 between the scroll mode and the link select mode, according to the user operation. That is, since the image is not scrolled on a link basis on the display screen in response to link selection, the user can easily grasp the entire Web page screen on the monitor with simple operation.

Further, in this television receiving system 1, the CPU 7 of the television receiver 2 determines the functions of the operating section 3B of the remote commander 3 depending on the operation mode, so that the user does not necessarily switch the setting of the operating section 3B of the remote commander 3 for each operation mode, thereby realizing user-friendly operation.

According to the above configuration, this television receiving system 1 allows a user to position a user-desired Web page screen by means of scroll and select a link with simple operation by alternatively switching the operation mode of the remote commander 3 between the scroll mode and the link select mode according to user operation while displaying part of the Web page screen on the display area of the monitor 9 of the television receiver 2. Therefore, the user is able to easily select a desired link while easily confirming the entire Web page, thus making it possible to realize the television receiving system capable of offering improved user usability.

### (5) Other Embodiments

In this embodiment described above, this invention is applied to the television receiving system 1 composed of a television receiver (image display apparatus) 2 for displaying a Web page screen (an image based on content information) having at least one link on the display area (display screen) of the monitor 9, and the remote commander (operating device) 3 for operating the displayed contents on the display area (display screen) of the television receiver (image display apparatus) 2. This invention, however, is not limited to this and can be widely applied to other various kinds of image display apparatuses and image display systems including the image display apparatuses.

For example, in a case where a portable telephone is applied as an image display apparatus and content information for personal computers is browsed as a Web page screen on the display screen of the portable telephone, the display screen is very small. Therefore, this invention is very effective because it is capable of easily selecting a desired link while allowing the entire Web page screen to be confirmed easily.

Further, in this embodiment, not only the television signal receiving unit 4 but also the communication circuit 5, the receiving circuit 6 and so on are installed in the television receiver 2. In addition to this, general television receivers can have the same effects by having a set-top box externally attached thereto, the set-top box containing the communication circuit 5, the receiving circuit 6 and the video processing circuit 8 shown in FIG. 1.

Still further, in this embodiment described above, in the television receiver 2 as the image display apparatus, a control means for controlling a display state of a Web page screen (an image based on content information) being displayed on the display area (display screen) of the monitor 9 and a mode switching means for switching the operation mode of the control means between the scroll mode (first mode) and the link select mode (second mode) according to the operation of the remote commander (operating device) 3 are realized by the CPU 7 of the television receiver 2. This invention, however, is not limited to this and other configuration can be applied, provided that a Web page screen can be scrolled on the display area in the scroll mode (first mode) and a link can be sequentially selected in the Web screen fixed on the display area in the link select mode (second mode) according to the operation of the remote commander (operating device) 3 in a situation where part of the Web page screen (image based on content information) is displayed in the display area (display screen) of the monitor 9.

Still further, in this embodiment, the remote commander 3 shown in FIG. 1 and FIG. 2 is applied as an operating device for remotely operating the television receiver 2. This invention, however, is not limited to this and can be widely applied to other kinds of operating devices. In this case, the operating devices and channel remote controllers can be combined by setting the function of the operating devices as part of the functions of the channel remote controllers unique to general television receivers.

Still further, the remote commander 3 serving as an operating device communicates various data with the television receiver 2 by the infrared communication. This invention, however, is not limited to this and data can be communicated by radio communication such as a wireless LAN such as Bluetooth, or by wired communication using a communication cable based on the IEEE 1394.

Still further, in the above embodiment, the remote commander 3 serving as the operating device has the cursor keys (first operating means) for designating directions and the OK key (second operating means) for confirmation. The CPU 7 serving as the control means fixes an image determined by the second operating means while scrolling the image in directions designated by the cursory keys (first operating means) in the scroll mode (first mode) and displays a Web page screen (image based on content information) corresponding to a link designated by the OK key (second operating means) while sequentially selecting a link existing in a direction designated by the cursor keys (first operating means), in the image fixed on the display screen in the link select mode (second mode). The configuration of the first and second operating means and the operation contents of the control means according to the operation of these means can be set to other various kinds of configuration and operation, provided that the positioning of the Web page screen by means of scroll and the link selection can be performed with simple operation.

Although the CPU 7 serving as the mode switching means switches the operation mode of the remote commander 3 from the scroll mode (first mode) to the link select mode (second mode) in response to pressing of the OK key (second operating means) in the scroll mode (first mode), a key for this mode switching can be newly provided to the operating section 3B of the remote commander 3.

An image display system, image display apparatus and image display method can be applied to television receivers and portable telephones capable of accessing the Internet.

While there has been described in connection with the preferred embodiments of the invention, it will be obvious to those skilled in the art that various changes and modifications may be aimed, therefore, to cover in the appended claims all such changed and modifications as fall within the true spirit and scope of the invention.

1. An image display system comprising an image display apparatus for displaying an image based on content information having at least one link on a display screen and an operating device for operating displayed contents of the display screen of the image display apparatus, wherein:
the image display apparatus comprises:
control means for controlling a display state of the image based on the content information being displayed on the display screen; and
mode switching means for switching an operation mode of the control means between first and second modes, according to operation of the operating device, wherein,
in a state where part of the image based on the content information is displayed on the display screen of the image display apparatus, the control means scrolls the image on the display screen in the first mode and sequentially selects a link in the image fixed on the display screen in the second mode, according to operation of the operating device.

2. The image display system according to claim 1, wherein:
the operating device has first operating means for designating directions and second operating means for confirmation, wherein
the control means fixes the image determined by the second operating means on the display screen while scrolling the image in directions designated by the first operating means in the first mode, and sequentially selects a link existing in a direction designated by the first operating means in the image fixed on the display screen and displays an image based on content information corresponding to a link designated by the second operating means in the second mode.

3. The image display system according to claim 2, wherein
the mode switching means switches the operation mode of the control means from the first mode to the second mode according to operation of the second operating means in the first mode.

4. An image display apparatus for displaying an image based on content information having at least one link on a display screen, comprising:
control means for controlling a display state of the image based on the content information being displayed on the display screen; and.
mode switching means for switching an operation mode of the control means between first and second modes according to external operation, wherein,
in a situation where part of the image based on the content information is displayed on the display screen, the control means scrolls the image on the display screen in the first mode and sequentially selects a link in the image fixed on the display screen in the second mode, according to the external operation.

5. The image display apparatus according to claim 4, wherein
the control means fixes the image determined on the display screen while scrolling the image-in designated directions in the first mode, and sequentially selects a link existing in a designated direction in the image fixed on the display screen and displays an image based on content information corresponding to a link designated in the second mode.

6. The image display apparatus according to claim 5, wherein
the mode switching means switches the operation mode of the control means from the first mode to the second mode according to operation of the second operating means in the first mode.

7. An image display method for displaying an image based on content information having at least one link on a display screen, comprising:
switching an operation mode for controlling a display state of the image based on the content information being displayed on the display screen between first and second modes according to external operation, and
scrolling the image on the display screen in the first mode and sequentially selecting a link in the image fixed on the display screen in the second mode, according to the external operation in a situation where part of the image based on the content information is displayed on the display screen.

8. The image display method according to claim 7, wherein:
the image is scrolled in designated directions and the image determined is fixed on the display screen in the first mode; and
a link existing in a designated direction is sequentially selected in the image fixed on the display screen and an image based on content information corresponding to a link designated is displayed in the second mode.
